(19) United States
(12) Patent Application Publication
(10) Pub. No.: US 2022/0379663 A1
(43) Pub. Date: Dec. 1, 2022

(54) Crown Reinforcement of a Tire for a Heavy Construction Plant Vehicle

(71) Applicant: COMPAGNIE GENERALE DES ETABLISSEMENTS MICHELIN, Clermont-Ferrand (FR)

(72) Inventors: Olivier SPINNLER, Clermont-Ferrand Cedex 9 (FR); Alain DOMINGO, Clermont-Ferrand Cedex 9 (FR); Jean Marc D’HARCOURT, Clermont-Ferrand Cedex 9 (FR)

(21) Appl. No.: 17/776,034

(22) PCT Filed: Nov. 12, 2020
(86) PCT No.: PCT/FR2020/052069

§ 371 Date: May 11, 2022

(30) Foreign Application Priority Data
Nov. 15, 2019 (FR) 1912773

(51) Int. Cl. B60C 9/00; B60C 9/20

(52) U.S. Cl. CPC B60C 9/0007; B60C 9/2006; B60C 2200/065; B60C 2009/0078; B60C 2009/0085; B60C 2009/0092; B60C 2009/208; B60C 2009/209; B60C 2009/2096; B60C 2009/2093

(57) ABSTRACT

A tire (1) for a heavy construction plant vehicle with satisfactory compromise between the breaking strength of its circumferential hoop reinforcement (7), having an axial width LF and having a circumferential hooping layer (71, 72) with elastic metallic reinforcers having a structural elongation AS and a force at break FR, and forming an angle at most equal to 5° with the circumferential direction (XX), and the endurance of its working reinforcement (6), formed by two working layers (61, 62) with inextensible metallic reinforcers, the mean angle AM of which with the circumferential direction (XX′) is at least equal to 15° and at most equal to 45°. The axial width LF, the structural elongation As, the force at break Fr and the mean angle AM satisfy the relationship:

Zn/Z0*(T0+(a1+a2*As)/AM+b*LF*(AM−A0)/A0+c*AM)<Fr/CS, where Zn is the nominal load, Z0=100 t, T0=7000 N, a1=−230,000 N*°, a2=−160,000 N*°/%, b=−34,000 N/m, A0=29°, c=550 N/°, CS>=1.

The present invention concerns a radial tire intended to be fitted to a heavy construction plant vehicle, and more specifically concerns its crown reinforcement.

Typically, a radial tire for a heavy construction plant vehicle is intended to be mounted on a rim, the diameter of which is at least equal to 25 inches, according to the standard of the European Tire and Rim Technical Organisation or ETRTO. Although not limited to this type of application, the invention is described for a radial tire of large size, which is intended to be mounted on a dumper, a vehicle for transporting materials extracted from quarries or surface mines, by way of a rim with a diameter at least equal to 49 inches, possibly as much as 57 inches, or even 63 inches.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to” and “further away from” the axis of rotation of the tire, respectively. “Axially inner/axially on the inside” and “axially outer/axially on the outside” mean “closer to” and “further away from” the equatorial plane of the tire, respectively, with the equatorial plane of the tire being the plane that passes through the middle of the tread surface and is perpendicular to the axis of rotation.

Generally, a tire comprises a tread intended to come into contact with the ground via a tread surface, and the two axial ends of which are connected via two sidewalls to two beads that provide the mechanical connection between the tire and the rim on which it is intended to be mounted.

A radial tire also comprises a reinforcement formed by a crown reinforcement radially on the inside of the tread and of a carcass reinforcement radially on the inside of the crown reinforcement.

The carcass reinforcement of a radial tire for a heavy construction plant vehicle usually comprises at least one carcass layer comprising generally metallic reinforcers coated in an elastomer-based material. A carcass layer comprises a main part that joins the two beads together and is generally wound, in each bead, from the inside of the tire to the outside, around a usually metal circumferential reinforcing element known as a bead wire so as to form a turn-up. The metallic reinforcers of a carcass layer are substantially mutually parallel and form an angle of between 85° and 95° with the circumferential direction.

The crown reinforcement of a radial tire for a heavy construction plant vehicle comprises a superposition of circumferentially extending crown layers, radially on the outside of the carcass reinforcement. Each crown layer is formed by generally metallic reinforcers that are mutually parallel and coated in an elastomer-based material.

With regard to the metallic reinforcers, a metallic reinforcer is mechanically characterized in extension by a curve representing the tensile force (in N) applied to the metallic reinforcer, as a function of its relative elongation (in %), known as the force-elongation curve. Mechanical tensile characteristics of the metallic reinforcer, such as the structural elongation As (in %), the total elongation at break At (in %), the force at break Fm (maximum load in N) and the breaking strength Rm (in MPa), are derived from this force-elongation curve, these characteristics being measured in accordance with the standard ISO 6892 of 1984.

The total elongation at break At of the metallic reinforcer is, by definition, the sum of its respective structural, elastic and plastic elongations (At=As+Ae+Ap). The structural elongation As results from the relative positioning of the metal threads making up the metallic reinforcer under a low tensile force. The elastic elongation Ae results from the intrinsic elasticity of the metal of the metal threads making up the metallic reinforcer, taken individually, wherein the behaviour of the metal follows Hooke's law. The plastic elongation Ap results from the plasticity, that is to say the irreversible deformation beyond the yield point, of the metal of these metal threads taken individually.

Also defined, at each point on the force-elongation curve of a metallic reinforcer, is a tensile modulus expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metallic reinforcers, a distinction is usually made between elastic metallic reinforcers and inextensible metallic reinforcers. An elastic metallic reinforcer is characterized by a structural elongation As at least equal to 1% and a total elongation at break At at least equal to 4%. Moreover, an elastic metallic reinforcer has a tensile elastic modulus at most equal to 150 GPa, and usually between 40 GPa and 150 GPa. An inextensible metallic reinforcer is characterized by a total elongation At under a tensile force equal to 10% of the force at break Fm, at most equal to 0.2%. Moreover, an inextensible metallic reinforcer has a tensile elastic modulus usually between 150 GPa and 200 GPa.

The mechanical characteristics described above relate to a bare metallic reinforcer, i.e. one which is not coated in a vulcanised elastomer-based material. These mechanical characteristics may be significantly different when the metallic reinforcer is coated in a vulcanised elastomer-based material. In particular, for an elastic metallic reinforcer generally formed by an assembly of strands of metallic threads, the structural elongation As of the coated reinforcer is significantly smaller than that of the bare reinforcer. In fact, when the bare elastic reinforcer is subjected to tension, the strands draw closer together until they come into mutual contact before the reinforcer becomes rigid. However, when the coated reinforcer is subjected to tension, the presence of the vulcanised elastomer-based material limits the extent to which the reinforcers can draw closer together, hence giving a lower structural elongation As in this case.

With regard to the crown layers of the crown reinforcement, a distinction is usually made between the protective layers which make up the protective reinforcement and are radially outermost, and the working layers which make up the working reinforcement and are radially contained between the protective reinforcement and the carcass reinforcement.

The protective reinforcement, which comprises at least one protective layer, essentially protects the working layers from mechanical or physicochemical attacks, which are likely to spread through the tread radially towards the inside of the tire.

The protective reinforcement often comprises two radially superposed protective layers formed of elastic metallic reinforcers that are mutually parallel in each layer and crossed from one layer to the next, forming angles at least equal to 10° with the circumferential direction.

The working reinforcement, comprising at least two working layers, has the function of belting the tire and ensuring its stiffness and road-holding. It absorbs both mechanical inflation stresses, which are generated by the tire inflation pressure and transmitted by the carcass reinforcement, and mechanical stresses caused by running, which are generated as the tire runs over the ground and are transmitted by the tread. It is also intended to withstand oxidation, impacts and perforation, by virtue of its intrinsic design and that of the protective reinforcement.

The working reinforcement usually comprises two radially superposed working layers formed of inextensible metallic reinforcers that are mutually parallel in each layer and crossed from one layer to the next, forming angles at most equal to 60°, and preferably at least equal to 15° and at most equal to 45°, with the circumferential direction.

Moreover, in order to reduce the mechanical inflation stresses that are transmitted to the working reinforcement, it is known to provide a hoop reinforcement having a high circumferential tensile stiffness, radially on the outside of the carcass reinforcement. The hoop reinforcement, the function of which is to at least partially absorb the mechanical inflation stresses, also improves the endurance of the crown reinforcement by stiffening the crown reinforcement when the tire is compressed under a radial load and, in particular, subjected to a cornering angle about the radial direction.

The hoop reinforcement comprises at least one hooping layer and usually at least two radially superposed hooping layers formed of metallic reinforcers that are mutually parallel in each layer and crossed from one layer to the next, forming angles at most equal to 10° with the circumferential direction. The hoop reinforcement may be positioned radially on the inside of the working reinforcement, between two working layers of the working reinforcement, or radially on the outside of the working reinforcement.

The hooping layers may be closed-angle hooping layers in which the metallic reinforcers form angles at least equal to 5° and at most equal to 10° with the circumferential direction, or circumferential hooping layers in which the metallic reinforcers form angles at most equal to 5° and possibly zero, with the circumferential direction. The closed-angle hooping layers comprise metallic reinforcers having free ends at their axial ends. The circumferential hooping layers comprise metallic reinforcers that do not have free ends at their axial ends, since the circumferential hooping layers are usually obtained by circumferentially winding a ply of metallic reinforcers, an elementary strip of metallic reinforcers, or a continuous metallic reinforcer. Such a hoop reinforcement is described for example in documents WO 2014048897 A1 and WO 2016139348 A1.

The document WO 2014048897 A1 has the objective of desensitizing the crown of a radial tire for a heavy construction plant vehicle to impacts that occur more or less at the centre of its tread, and describes an additional reinforcement centred on the equatorial plane of the tire, comprising at least one additional layer formed of metallic reinforcers that make an angle at most equal to 10° with the circumferential direction, the metallic reinforcers of each additional layer being elastic and having a tensile elastic modulus at most equal to 150 GPa. The additional reinforcement, described in that document, is therefore a hoop reinforcement having elastic metallic reinforcers, wherein the hooping layers may be either closed-angle hooping layers or circumferential hooping layers.

Document WO 2016139348 A1 has the objective of improving the performance with regard to both endurance against splitting and impact resistance of the crown of a tire for a heavy construction plant vehicle, and describes a hoop reinforcement formed by a circumferential winding of a ply so as to form a radial stack of at least two hooping layers, comprising circumferential elastic metallic reinforcers that make angles at most equal to 2.5° with the circumferential direction, the hoop reinforcement being radially positioned between the working layers, and the circumferential metallic reinforcers of the hoop reinforcement having a force at break at least equal to 800 daN. The hoop reinforcement described in that document is therefore a hoop reinforcement formed by circumferential hooping layers having elastic metallic reinforcers.

In the particular case of a hoop reinforcement having circumferential hooping layers, when the running tire is subjected to an axial load parallel to its axis of rotation, also known as transverse load or lateral load, the axial ends of the circumferential hooping layers are subjected to considerable tensions owing to edgewise bending, about a radial axis, of the crown reinforcement as a whole. In other words, the axially outermost metallic reinforcers of the circumferential hooping layers are thus subjected to great elongations, which can cause them to break and, consequently, can damage the hoop reinforcement, this being able in turn to damage the crown reinforcement and cause the tire to be withdrawn from service prematurely.

In order to reduce the tensions in the metallic reinforcers positioned at the axial ends of the circumferential hooping layers, it is known, for example, to reduce the angles formed, by the metallic reinforcers of the working layers with the circumferential direction, in order to increase the contribution of the working reinforcement to the hooping of the tire. It is also known to reduce the tensile elastic modulus of the metallic reinforcers of the circumferential hooping layers, or increase their structural elongation, and hence to increase their elongation capacity. However, the above-described solutions have the drawback of generating an increase in shear stress at the axial ends of the working layers, and therefore of reducing the endurance of the crown reinforcement; this is contrary to the objective of hooping which is, in particular, to control said shear stresses and, consequently, to ensure satisfactory endurance of the crown reinforcement.

Thus the aim for an adequate braking strength of the hoop reinforcement may lead to a reduction in endurance of the crown reinforcement, in particular when the tire is cornering, under the action of a transverse stress.

The inventors have set themselves the objective, for a radial tire for a heavy construction plant vehicle, comprising a hoop reinforcement having circumferential hooping layers, of finding a satisfactory compromise between the breaking strength of the hoop reinforcement and the endurance of the working reinforcement while the tire is running, in particular cornering.

This objective has been achieved, according to the invention, by a tire for a heavy construction plant vehicle, intended to carry a nominal load Zn, comprising a crown reinforcement radially on the inside of a tread and radially on the outside of a carcass reinforcement:
the crown reinforcement comprising a working reinforcement and a circumferential hoop reinforcement,
the working reinforcement having an axial width LT and being formed by a first and a second working layer, each comprising inextensible metallic reinforcers having a tensile elastic modulus of more than 150 GPa, coated with an elastomer-based material and mutually parallel, and one working layer crossing the next, such that the mean angle AM of the metallic reinforcers of the working reinforcement, defined as the geometric mean of the respective angles formed by the reinforcers of the first and second working layers with a circumferential direction tangential to the circumference of the tire, is at least equal to 15° and at most equal to 45°,
the circumferential hoop reinforcement having an axial width LF at least equal to 0.3 times the axial width LT of the working reinforcement and comprising at least one circumferential hooping layer formed from elastic metallic reinforcers having a tensile elastic modulus of more than 150 GPa, coated with an elastomer-based material and mutually parallel, and forming with the circumferential direction an angle at most equal to ⁵°,
the elastic metallic reinforcers of the circumferential hoop reinforcement, removed from the tire with their coating of vulcanised elastomer-based material, having a structural elongation As at least equal to 0.5% and a force at break Fr,
characterized in that the axial width LF of the circumferential hoop reinforcement, the structural elongation As of the elastic metallic reinforcers of the circumferential hoop reinforcement and the force at break Fr of the elastic metallic reinforcers of the circumferential hoop reinforcement, and the mean angle AM of the inextensible metallic reinforcers of the working reinforcement, satisfy the relationship:

Zn/Z0*(T0+(a1+a2*As)/AM+b*LF*(AM−A0)/A0+c*AM)<Fr/CS where
Zn: the nominal load (expressed in tonnes) applied to the tire,
Z0: reference load equal to 100 tonnes,
T0: reference tension equal to 7000 N,

a1=−230,000 N*°,

a2=−160,000 N*°/%,

b=−34,000 N/m,
A0: mean reference angle of the metallic reinforcers of the working reinforcement equal to 29°,

c=550 N/°,
CS: safety coefficient at least equal to 1.

The invention essentially comprises optimisation of a hoop reinforcement with elastic metallic reinforcers in combination with a working reinforcement with inextensible metallic reinforcers. The design parameters of the hoop reinforcement which were taken into account are firstly its axial width, which defines the crown reinforcement zone, and secondly the respective characteristics of extension of the elastic metallic reinforcers, which defines the deformability of the hoop reinforcement, and of their force at break, which defines its breaking strength. The design parameter which was taken into account for the working reinforcement is the mean angle of the inextensible metallic reinforcers, defined as the geometric mean of the angles formed by the respective reinforcers of the first and second working layers with the circumferential direction of the tire. This mean angle characterizes the triangulation function of the working reinforcement: the larger this mean angle, the less the working reinforcement contributes to the circumferential stiffness of the tire and the absorption of circumferential forces.

The relationship verified by the respective characteristics of the hoop reinforcement and the working reinforcement described above may, according to the invention, be interpreted as an estimate of the maximum tension of the reinforcer of the hoop reinforcement which is under most tension when the hoop reinforcement is subjected to edgewise bending around a radial axis, wherein the running tire is subjected to a transverse force FY in the axial direction of the tire which is equal to 0.7 times the nominal load Zn as recommended for example by the European standard of ETRTO or the American standard of the Tire and Rim Administration (TRA). This maximum tension of the hooping reinforcer must remain lower than the force at break Fr of the reinforcer divided by a safety coefficient CS.

For a given transverse acceleration, the transverse force and hence the maximum tension within the hoop reinforcement are directly proportional to the mass transported. With the aim of optimising productivity, a mining operator will usually load trucks up to the nominal load for the tire. Thus the term Zn/Z0 signifies that the maximum tension of the hoop reinforcement in average usage is proportional to the nominal load of the tire.

The term (a1+a2*As)/AM, where a1 and a2 are negative, means that for a given mean angle AM, the maximum tension of the hooping reinforcer diminishes linearly with the structural elongation As, measured on a reinforcer removed from the tire and hence coated in a vulcanised elastomer-based material.

The term b*LF*(AM−A0)/A0, where b is negative, shows that the effect of the hooping width on the maximum tension depends on the value of the mean angle AM relative to a mean reference angle value of A0 equal to 29°. For a mean angle AM greater than the reference angle A0, an increase in the hooping width leads to a reduction in the maximum tension. However, for a mean angle AM smaller than the reference angle A0, an increase in the hooping width leads to an increase in the maximum tension.

The term c*AM, where C is positive, means that the maximum angle of the hooping reinforcer increases with the mean angle AM. But the contribution of the angle AM is in fact more complex since it depends on the parameters of the structural elongation As and the hooping width LF. Depending on the respective values of As and LF, the maximum tension of the hooping reinforcer grows with the angle AM in monotonous fashion or with a maximum.

The second element in the inequality claimed by the invention is the ratio Fr/CS between the force at break Fr of an elastic metallic reinforcer of the hoop reinforcement and a safety coefficient CS which is at least equal to 1. In practice, the safety coefficient CS is set to be equal to 1 when the tire is running on a well-maintained road or track. However, the safety coefficient CS is set to be strictly greater than 1, for example equal to 1.2, when the tire is running on a road or track with bends and/or obstacles, such as rocks on the ground.

Preferably, the elastic metallic reinforcers of each circumferential hooping layer form an angle equal to 0° with the circumferential direction. Such a circumferential hooping layer may be produced by winding a ply of reinforcers at 0°, as described in document WO 2016139348. This industrial embodiment is economically advantageous since the duration of the laying cycle of such a ply is shorter than in the case of a helical winding of a reinforcer strip.

The elastic metallic reinforcers of each circumferential hooping layer generally have a tensile elastic modulus at least equal to 40 GPa, preferably at least equal to 75 GPa. The role of the hooping is to at least partially absorb the circumferential tension absorbed by the working layers and to limit the risk of splitting, i.e. cracking at the ends of the working layers, wherein a minimum level of stiffness of the elastic metallic reinforcers is required in order to perform this function effectively.

According to a preferred embodiment, the elastic metallic reinforcers of each circumferential hooping layer are multistrand ropes of structure 1×N comprising a single layer of N strands wound in a helix, each strand comprising an internal layer of M internal threads wound in a helix and an external layer of K external threads wound in a helix around the internal layer. The formulas of multistrand ropes are conventional assemblies for elastic ropes.

According to a preferred variant of the preferred embodiment of the elastic metallic reinforcers, the single layer of N strands, wound in a helix, comprises N=3 or N=4 strands, preferably N=4 strands.

More particularly, the internal layer of M internal threads, wound in a helix, of each strand comprises M=3, 4 or 5 internal threads, preferably M=3 internal threads.

Even more particularly, the external layer of K external threads, wound in a helix around the internal layer of each strand, comprises K=7, 8, 9, 10 or 11 external threads, preferably K=8 external threads.

Advantageously, the circumferential hoop reinforcement has an axial width LF at most equal to 0.9 times the axial width LT of the working reinforcement. It is in fact important to keep the axial ends of the hooping layers axially inside those of the working layers. The axial ends of the working layers are indeed zones susceptible to the initiation of cracks. A crack in the hoop reinforcement may cause its breakage by friction wear of the metallic reinforcers, which would cancel out the beneficial effect of the hooping.

Preferably, the force at break Fr of each elastic metallic reinforcer of the circumferential hoop reinforcement is at least equal to 8000 N. This is a minimum required taking into account the stresses applied to the tire intended to be fitted to a heavy construction plant vehicle.

According to a preferred embodiment, the circumferential hoop reinforcement is positioned radially between the first working layer and the second working layer. In other words, it is sandwiched between the two working layers. In order to protect the hoop reinforcement from external attack, it is beneficial to position this radially between the working layers which then form an additional barrier against attack. However, positioning the hooping layers radially inside the working reinforcement leads to over-tensioning of their reinforcers when passing over an obstacle, resulting from the counter-curvature induced on the crown and the circumferential angulation of the hooping layer reinforcers. Consequently, positioning the hoop reinforcement radially between the working layers constitutes a good compromise between the respective risks of attack and over-tensioning of the hoop reinforcement.

According to a variant of the above-mentioned preferred embodiment, the two working layers of the working reinforcement come into contact with one another at their respective axial ends so as to form a coupling zone axially inside a decoupling zone in which the axial ends are spaced apart from one another.

In the particular case in which the hoop reinforcement is positioned between the two working layers, the two working layers are consequently spaced apart from one another by a radial distance equal to the radial thickness of the hoop reinforcement. A coupling zone means a zone in which the two working layers come back into contact with one another beyond the hooping zone, axially outside the hoop reinforcement. The coupling zone this allows local stiffening of the working reinforcement. A decoupling zone means a zone in which the two working layers move apart from one another again, axially outside the coupling zone. The decoupling zone allows a reduction in shear stresses at the axial ends of the working layers and hence limits the risk of cracking in this zone.

Usually, the circumferential hoop reinforcement is formed by two circumferential hooping layers. Two circumferential hooping layers are generally necessary to obtain the desired level of circumferential stiffness and hence hooping.

Preferably, the crown reinforcement comprises, radially outermost, a protective reinforcement comprising at least one protective layer formed by elastic metallic reinforcers having a tensile elastic modulus at most equal to 150 GPa, which are coated in an elastomer-based material, are mutually parallel and form an angle at least equal to 10° with a circumferential direction tangential to the circumference of the tire.

The protective reinforcement usually comprises two protective layers, the elastic metallic reinforcers of which form an angle at least equal to 15° with the circumferential direction.

According to a particular embodiment, the radially innermost protective layer is axially the widest of all layers of the crown reinforcement. This protective layer is then described as overlapping since its axial ends overlap those of other crown layers, which guarantees good protection of the latter. In this configuration, there are no mechanical interactions between the protective layers and the hooping layers.

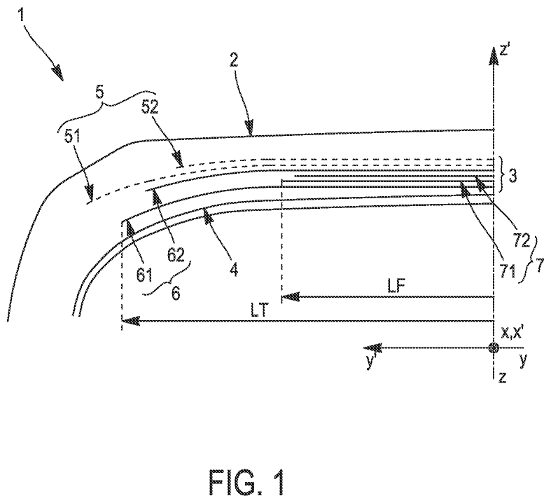

The features of the invention are illustrated by the schematic FIGS. 1 to 5, which are not drawn to scale:

FIG. 1: A meridian half-section of a crown of a tire for a heavy construction plant vehicle according to the invention.

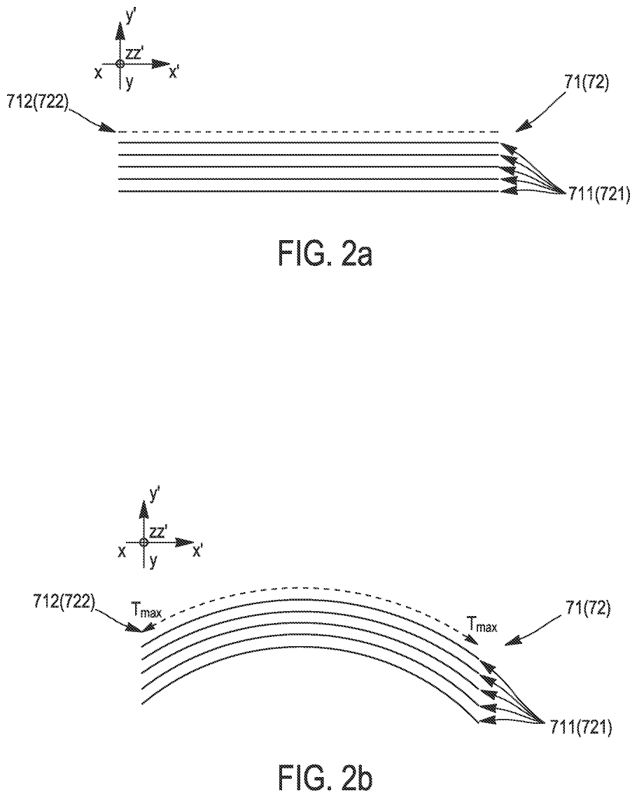

FIG. 2a: A developed schematic view of a circumferential hooping layer at rest.

FIG. 2b: A developed schematic view of a circumferential hooping layer under edgewise bending.

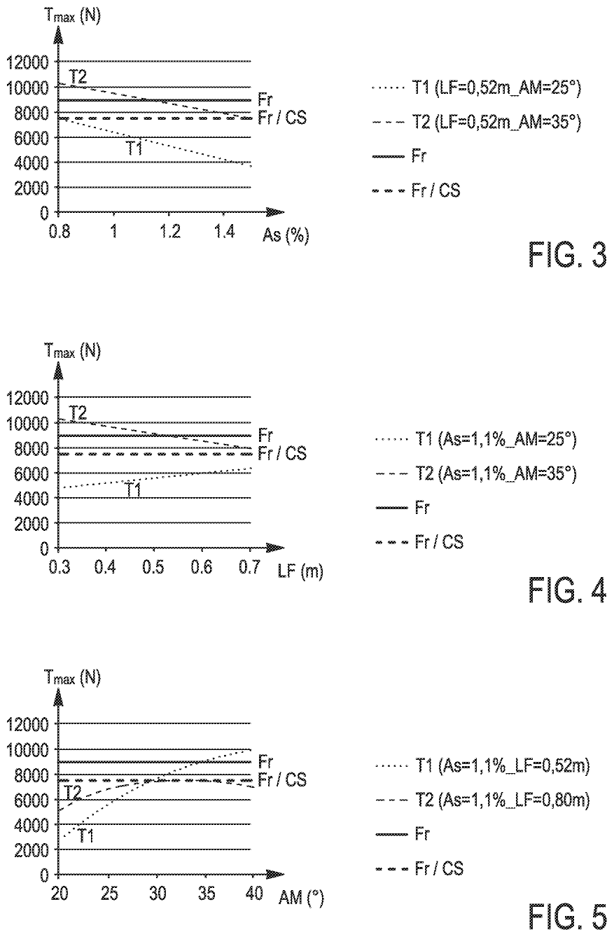

FIG. 3: A development of the maximum hooping reinforcer tension Tmax as a function of the structural elongation As of the elastic metallic reinforcers of the hoop reinforcement.

FIG. 4: A development of the maximum hooping reinforcer tension Tmax as a function of the axial width LF of the hoop reinforcement.

FIG. 5: A development of the maximum hooping reinforcer tension Tmax as a function of the mean angle AM of the inextensible metallic reinforcers of the working reinforcement.

FIG. 1 shows a meridian half-section, on a plane YZ, of a tire 1 for a heavy construction plant vehicle according to the invention, comprising a crown reinforcement 3 radially on the inside of a tread 2 and radially on the outside of a carcass reinforcement 4. The crown reinforcement 3 comprises, radially from the outside to the inside, a protective reinforcement 5 and a working reinforcement 6. The protective reinforcement 5 comprises two protective layer (51, 52) each comprising elastic metallic reinforcers having a tensile elastic modulus at most equal to 150 GPa, which are coated in an elastomer-based material, are mutually parallel, and form an angle at least equal to 10° (not shown) with a circumferential direction XX′ tangential to the circumference of the tire, and are crossed from one protective layer to the next. The working reinforcement 6 has two working layers (61, 62) each comprising inextensible metallic reinforcers having a tensile elastic modulus of more than 150 GPa, coated with an elastomer-based material and mutually parallel, and one working layer crossing the next such that the mean angle AM of the metallic reinforcers of the working reinforcement (6), defined as the geometric mean of the respective angles formed by the reinforcers of the first and second working layers (61, 62) with the circumferential direction (XX′), is at least equal to 15° and at most equal to 45°. The working reinforcement 6 has an axial width LT defined as the width of the widest working layer, which, in the example shown, is the radially innermost working layer 61. The crown reinforcement 3 also comprises a circumferential hoop reinforcement 7 positioned radially between the two working layers (61, 62) of the working reinforcement 6. The circumferential hoop reinforcement 7 has an axial width LF, defined as the greatest width of the hooping layer, at least equal to 0.3 times the axial width LT and comprises two circumferential hooping layers (71, 72) formed from elastic metallic reinforcers having a tensile elastic modulus of more than 150 GPa, coated with an elastomer-based material and mutually parallel, and forming with the circumferential direction XX′ an angle at most equal to 5°. The elastic metallic reinforcers of the circumferential hoop reinforcement 7, removed from the tire with their vulcanised elastomer-based material coating, have a structural elongation As at least equal to 0.5% and a force at break Fr at least equal to 9000 N. In view of the depiction of the invention on a meridian half-section which is symmetrical relative to the plane XZ, only the respective halves of the widths LF and LT are shown.

FIG. 2a shows a developed schematic view of a circumferential hooping layer (71, 72) at rest. The elastic metallic reinforcer (712, 722) designed to be under the most tension when the tire is subject to a transverse force FY during running, depending on the axial direction of the tire, equal to 0.7 times the nominal load Zn, is depicted in dotted lines while the other elastic metallic reinforcers (711, 712) are depicted in solid lines. At rest, all of these elastic metallic reinforcers, which are mutually parallel, are positioned in circumferential planes XZ.

FIG. 2b shows a developed schematic view of a circumferential hooping layer (71, 72) deformed by edgewise bending, when the tire is subjected to a transverse force FY, depending on the axial direction of the tire, equal to 0.7 times the nominal load Zn. The elastic metallic reinforcer (712, 722), positioned on the external fibre of the beam in extension constituted by the crown reinforcement, is under most tension while the other elastic metallic reinforcers (711, 721) are subjected to lower tensile forces.

FIG. 3 shows the development of the maximum hooping reinforcer tension Tmax as a function of the structural elongation As of the elastic metallic reinforcers of the hoop reinforcement. The maximum hooping reinforcer tension Tmax is the tension of the elastic metallic reinforcer of the hoop reinforcement which is under most tension when the tire is subject to a transverse force FY, depending on its axial direction, equal to 0.7 times the nominal load Zn, leading to a deformation of the hoop reinforcement by edgewise bending. FIG. 3 shows as a solid line a first maximum limit corresponding to the force at break Fr of a reinforcer, and as a broken line a second permitted limit corresponding to the force at break Fr of a reinforcer divided by a safety coefficient CS equal to 1.2. The straight dotted line T1 and broken line T2 show the development of Tmax as a function of As for a mean angle AM respectively equal to 25° and 35°, and for an axial width LF of the hoop reinforcement equal to 0.52 m. In both cases, Tmax reduces when As increases, with a smaller reduction when AM is higher. The straight line T1 lies fully within the permitted range since Tmax remains lower than the permitted limit Fr/CS. However, the straight line T2 is fully outside the permitted range since Tmax remains greater than the permitted limit Fr/CS, but has a portion passing below the maximum limit Fr.

FIG. 4 shows the development of the maximum hooping reinforcer tension Tmax as a function of the axial width LF of the hoop reinforcement. FIG. 4 shows as a solid line a first maximum limit corresponding to the force at break Fr of a reinforcer, and as a broken line a second permitted limit corresponding to the force at break Fr of a reinforcer divided by a safety coefficient CS equal to 1.2. The straight lines T1 and T2 show the development of Tmax as a function of LF for a mean angle AM respectively equal to 25° and 35°, and a structural elongation As equal to 1.1%. In the case of the dotted straight line T1, Tmax increases when the axial width LF of the hoop reinforcement increases, since the mean angle AM equal to 25° is smaller than the reference mean angle A0 equal to 29°. The straight line T1 lies fully within the permitted range since Tmax remains lower than the permitted limit Fr/CS. In the case of the broken straight line T2, Tmax reduces when the axial width LF of the hoop reinforcement increases, since the mean angle AM equal to 35° is larger than the reference mean angle A0 equal to 29°. However, the straight line T2 is fully outside the permitted range since Tmax remains greater than the permitted limit Fr/CS, but has a portion passing below the maximum limit Fr.

FIG. 5 shows the development of the maximum hooping reinforcer tension Tmax as a function of the mean angle AM of the elastic metallic reinforcers of the hoop reinforcement. FIG. 5 shows as a solid line a first maximum limit corresponding to the force at break Fr of a reinforcer, and as a broken line a second permitted limit corresponding to the force at break Fr of a reinforcer divided by a safety coefficient CS equal to 1.2. The curves T1 and T2 show the development of Tmax as a function of AM for an axial width LF of the hoop reinforcement respectively equal to 0.52 m and 0.80 m, and a structural elongation As equal to 1.1%. In the case of the dotted curve T1, Tmax increases continuously, passing the permitted limit and then the maximum limit. In the case of the broken curve T2, Tmax increases, passes through a maximum and then reduces, while remaining below the permitted limit. This curve T2 allows definition of an optimum mean angle AM for a given axial width LF and given structural elongation As, which can guarantee the breaking strength of the hoop reinforcement and an optimum endurance of the working reinforcement with respect to splitting.

The inventors have assessed the invention in two dimensions of tires for construction plant vehicles, respectively 40.00R57 and 53/80R63, for which the characteristics verifying the criteria of the invention are shown in table 1 below:

TABLE 1

| Dimension | 40.00R57 | 53/80R63 |
|---|---|---|
| Nominal load Zn applied to | 60,000 kg (ETRTO) | 82,500 kg (TRA) |
| the tire (reference | | |
| standard) | | |
| Axial width LF of | 0.35 m | 0.52 m |
| circumferential hoop | | |
| reinforcement | | |
| Force at break Fr of elastic | 9000N | 9000N |
| metallic reinforcers of | | |
| circumferential hoop | | |
| reinforcement | | |
| Structural elongation AS of | 0.7% | 1.1% |
| elastic metallic reinforcers | | |
| of circumferential hoop | | |
| reinforcement | | |
| Mean angle AM of | 33° | 29° |
| inextensible metallic | | |
| reinforcers of working | | |
| reinforcement | | |
| Maximum hooping tension | 7887N | 7384N |
| Tmax (in reinforcer under | | |
| most tension) | | |

The inventors have been able to verify by experiment, using the two examples above, a satisfactory compromise between the breaking strength of the hoop reinforcement and the endurance of the working reinforcement during running of the tire, in particular during cornering.

1. A tire for a heavy construction plant vehicle, intended to carry a nominal load Zn, comprising a crown reinforcement radially on the inside of a tread and radially on the outside of a carcass reinforcement:
the crown reinforcement comprising a working reinforcement and a circumferential hoop reinforcement,
the working reinforcement having an axial width LT and being formed by a first and a second working layer each comprising inextensible metallic reinforcers having a tensile elastic modulus of more than 150 GPa, coated with an elastomer-based material and mutually parallel, and one working layer crossing the next such that the mean angle AM of the metallic reinforcers of the working reinforcement, defined as the geometric mean of the respective angles formed by the reinforcers of the first and second working layers with a circumferential direction (XX′) tangential to the circumference of the tire, is at least equal to 15° and at most equal to 45°,
the circumferential hoop reinforcement having an axial width LF at least equal to 0.3 times the axial width LT of the working reinforcement and comprising at least one circumferential hooping layer formed from elastic metallic reinforcers having a tensile elastic modulus of more than 150 GPa, coated with an elastomer-based material and mutually parallel, and forming with the circumferential direction (XX′) an angle at most equal to 5°,
the elastic metallic reinforcers of the circumferential hoop reinforcement, removed from the tire with their coating of vulcanised elastomer-based material, having a structural elongation As at least equal to 0.5% and a force at break Fr,
wherein the axial width LF of the circumferential hoop reinforcement, the structural elongation As and the force at break Fr of the elastic metallic reinforcers of the circumferential hoop reinforcement, and the mean angle AM of the inextensible metallic reinforcers of the working reinforcement, satisfy the relationship:
Zn/Z0*(T0+(a1+a2*As)/AM+b*LF*(AM−A0)/A0+c*AM)<Fr/CS where
Zn: the nominal load (expressed in tonnes) applied to the tire,
Z0: reference load equal to 100 tonnes,
T0: reference tension equal to 7000 N,
a1=−230,000 N*°,
a2=−160,000 N*°/%,
b=−34,000 N/m,
A0: mean reference angle of metallic reinforcers of the working reinforcement equal to 29°,
c=550 N/°,
CS: safety coefficient at least equal to 1.

2. The tire for a heavy construction plant vehicle according to claim 1, wherein the elastic metallic reinforcers of each circumferential hooping layer form an angle equal to 0° with the circumferential direction (XX′).

3. The tire for a heavy construction plant vehicle according to claim 1, wherein the elastic metallic reinforcers of each circumferential hooping layer have a tensile elastic modulus at least equal to 40 GPa.

4. The tire for a heavy construction plant vehicle according to claim 1, wherein the elastic metallic reinforcers of each circumferential hooping layer are multistrand ropes of structure 1×N comprising a single layer of N strands wound in a helix, each strand comprising an internal layer of M internal threads wound in a helix and an external layer of K external threads wound in a helix around the internal layer.

5. The tire for a heavy construction plant vehicle according to claim 4, wherein the single layer of N strands, wound in a helix, comprises N=3 or N=4 strands.

6. The tire for a heavy construction plant vehicle according to claim 4, wherein the internal layer of M internal threads, wound in a helix, of each strand comprises M=3, 4, or 5 internal threads, preferably M=3 internal threads.

7. The tire for a heavy construction plant vehicle according to claim 4, wherein the external layer of K external threads, wound in a helix around the internal layer of each strand, comprises K=7, 8, 9, 10 or 11 external threads.

8. The tire for a heavy construction plant vehicle according to claim 1, wherein the force at break Fr of each elastic metallic reinforcer of the circumferential hoop reinforcement is at least equal to 8000 N.

9. The tire for a heavy construction plant vehicle according to claim 1, wherein the circumferential hoop reinforcement has an axial width LF at most equal to 0.9 times the axial width LT of the working reinforcement.

10. The tire for a heavy construction plant vehicle according to claim 1, wherein the circumferential hoop reinforcement is positioned radially between the first working layer and the second working layer.

11. The tire fa a heavy construction plant vehicle according to claim 9, wherein the two waking layers of the working reinforcement come into contact with one another at their respective axial ends, so as to form a coupling zone axially inside a decoupling zone in which the axial ends are spaced apart from one another.

12. The tire fa a heavy construction plant vehicle according to claim 1, wherein the circumferential hoop reinforcement comprises at least two circumferential hooping layers.

13. The tire fa a heavy construction plant vehicle according to claim 1, wherein the crown reinforcement comprises, radially outermost, a protective reinforcement comprising at least one protective layer formed by elastic metallic reinforcers having a tensile elastic modulus at most equal to 150 GPa, coated with an elastomer-based material, mutually parallel and forming an angle at least equal to 10° with the circumferential direction (XX′) tangential to the circumference of the tire.

14. The tire for a heavy construction plant vehicle according to claim 13, wherein the protective reinforcement is formed by two protective layers the elastic metallic reinforcers of which form an angle at least equal to 15° with the circumferential direction (XX′).

15. The tire for a heavy construction plant vehicle according to claim 13, wherein the radially innermost protective layer is axially the widest of all layers of the crown reinforcement.
